(19) United States
(12) Patent Application Publication
(10) Pub. No.: US 2014/0210706 A1
(43) Pub. Date: Jul. 31, 2014

(54) ELECTRONIC DEVICE EMPLOYING A FLEXIBLE DISPLAY AND OPERATING METHOD THEREOF

(71) Applicant: Samsung Electronics Co., Ltd., Gyeonggi-do (KR)

(72) Inventors: Su-Young Park, Gyeonggi-do (KR); Yang-Su Kim, Gyeonggi-do (KR); Sung-Ho Son, Daegu (KR); Keum-Ju Jang, Seoul (KR)

(73) Assignee: Samsung Electronics Co., Ltd., Gyeonggi-do (KR)

(21) Appl. No.: 14/146,600

(22) Filed: Jan. 2, 2014

(30) Foreign Application Priority Data
Jan. 25, 2013 (KR) 10-2013-0008407

(51) Int. Cl. G06F 3/03

(52) U.S. Cl. CPC G06F 3/03
USPC 345/156

(57) ABSTRACT

An electronic device to which a flexible display is applied and an operating method thereof. The content display method for viewing simple content such as a current time, a date, or the number of received massages without unfolding the folded flexible display, when a flexible display is folded for carrying.

### CROSS-REFERENCE TO RELATED APPLICATION AND CLAIM OF PRIORITY

The present application is related to and claims priority under 35 U.S.C. §119 to an application filed in the Korean Intellectual Property Office on Jan. 25, 2013 and assigned Serial No. 10-2013-0008407, the contents of which are incorporated herein by reference.

### TECHNICAL FIELD

The present disclosure relates generally to an electronic device to which a flexible display is applied and an operating method thereof.

### BACKGROUND

An electronic device such as a mobile phone, a portable multimedia player (PMP), or a personal digital assistant (PDA) is widely distributed as an essential item. Generally, an electronic device includes a display such as a liquid crystal display (LCD), an organic light emitting diode (OLED), and an active matrix OLED (AMOLED), and a substrate of the display is a glass substrate typically. An e-book or e-paper, to which a flexible display is applied, is commercialized. The flexible display can bend or fold as a bendable plastic film is applied to a substrate thereof, and thus, can be used in various fields. However, when a flexible display is folded for carrying, content, such as a text message or an image, is displayed on an area where a user has difficulty in viewing. The user feels inconvenienced to unfold the flexible display for viewing. Therefore, a content displaying method is necessary to display a user simple content such as a current time, a date or received massage-related information (for example, a message reception notification, the number of received messages) without unfolding the folded flexible display.

### SUMMARY

To address the above-discussed deficiencies, embodiments of the present disclosure provide an electronic device employing a flexible display and an operating method thereof.

Embodiments of the present disclosure provide an improved content display method in an electronic device employing a flexible display and the electronic device.

Embodiments of the present disclosure provide a content display method of viewing simple content such as a current time, a date or the number of received massages without unfolding the folded flexible display, when a flexible display is folded for carrying.

Embodiments of the present disclosure include a method of operating an electronic device including: obtaining at least one piece of bending information on a flexible display; determining at least one display area on the flexible display according the obtained bending information; and displaying a content on the determined display area.

In certain embodiments, the bending information includes a position of a bended line, or the position of the bended line and a bending angle of the bended line of the flexible display.

In certain embodiments, the position of the bended line is determined by measuring tension of the flexible display when the flexible display is folded.

In certain embodiments, the position of the bended line is determined by connecting points on which the largest tension is applied on one axis of the flexible display.

In certain embodiments, the determining of the at least one display area includes determining through distance comparison between the bended line and a center line of the one axis of the flexible display.

Certain embodiments of the present disclosure include converting the flexible display into an idle mode, when a bended line position of the flexible display, which corresponds to the bending information, is identical to a center line of one axis of the flexible display.

In certain embodiments, the content includes at least one of a current time, a current date, a message reception notification, and a set alarm mark.

Certain embodiments of the present disclosure include an electronic device that includes: a sensor device obtaining bending information on a flexible display; a processor determining a display area on the flexible display according to the bending information; and a flexible display displaying content corresponding to the bending information on the display area.

In certain embodiments, the bending information includes a bended line position, or the bended line position and a bending angle of the bended line of the flexible display.

In certain embodiments, when the flexible display is folded, the sensor device measures tension of the flexible display to determine the bended line position.

In certain embodiments, the sensor device determines a line connecting points on which the largest tension is applied on one axis of the flexible display to be the bended line position.

In certain embodiments, the processor determines the display area through distance comparison between the bended line position and a center line of the one axis of the flexible display.

In certain embodiments, when a bended line position of the flexible display, which corresponds to the bending information, is identical to a center line on one axis of the flexible display, the processor converts the flexible display into an idle mode.

In certain embodiments, the content includes at least one of a current time, a current date, a message reception notification, and a set alarm mark.

Certain embodiments of the present disclosure include an electronic device includes: a sensor device obtaining bending information on a flexible display; at least one processor; a memory; and at least one program stored in the memory and being executed by the at least one processor, wherein the program determines a display area of the flexible display according to the bending information, and displays content corresponding to the bending information on the display area.

In certain embodiments, the bending information comprises a bend line position, or the bended line position and a bending angle of the bended line of the flexible display.

In certain embodiments, when the flexible display is folded, the sensor device determines the bended line position by measuring tension of the flexible display.

In certain embodiments, the sensor device determines a line connecting points on which the largest tension is applied on one axis of the flexible display to be the bended line position.

In certain embodiments, wherein the processor determines the display area through distance comparison between the bended line position and a center line of the one axis of the flexible display.

In certain embodiments, when a bended line position of the flexible display, which corresponds to the bending information, is identical to a center line on one axis of the flexible display, the processor converts the flexible display into an idle mode.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates flexing of an electronic device according to embodiments of the present disclosure;

FIG. 1B illustrates a configuration of an electronic device according to embodiments of the present disclosure;

FIG. 2 illustrates a method of operating an electronic device according to embodiments of the present disclosure;

FIG. 3 illustrates a method of operating an electronic device according to embodiments of the present disclosure;

FIG. 4 illustrates an operation to display content according to a bended line position of FIG. 3;

FIG. 5 illustrates a method of operating an electronic device according to embodiments of the present disclosure;

FIG. 6A illustrates an operating method of an electronic device according to embodiments of the present disclosure;

FIG. 6B illustrates a position of a bended line of the flexible display of FIG. 6A;

FIG. 7A illustrates an operating method of an electronic device according to embodiments of the present disclosure;

FIG. 7B illustrates a position of a bended line of the flexible display of FIG. 7A;

FIG. 8A illustrates an operating method of an electronic device according to embodiments of the present disclosure;

FIG. 8B illustrates a position of a bended line of the flexible display of FIG. 8A;

FIG. 9A illustrates an operating method of an electronic device according to embodiments of the present disclosure;

FIG. 9B illustrates a position of a bended line of the flexible display of FIG. 9A;

FIG. 10A illustrates an operating method of an electronic device according to embodiments of the present disclosure;

FIG. 10B illustrates a position of a bended line of the flexible display of FIG. 10A;

FIG. 11A illustrates a state where a flexible display is folded twice according to embodiments of the present disclosure;

FIG. 11B illustrates a position of a bended line of the flexible display of FIG. 11A;

FIG. 11C illustrates a position of a bended line according to embodiments of the present disclosure; and

FIG. 12 illustrates a state where a flexible display is modified according to embodiments of the present disclosure.

### DETAILED DESCRIPTION

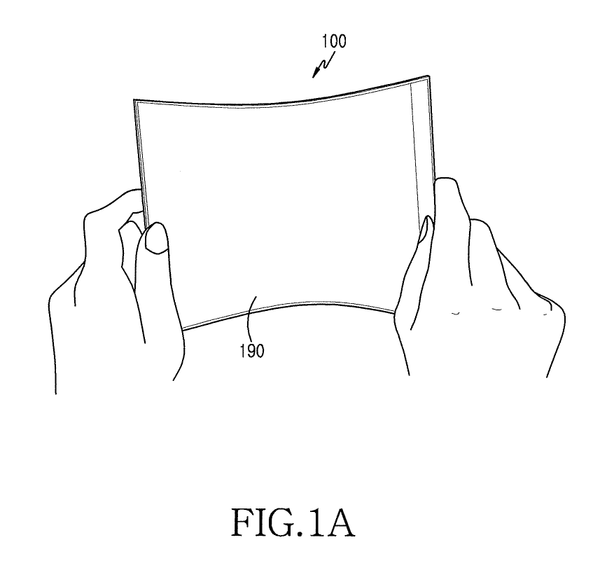

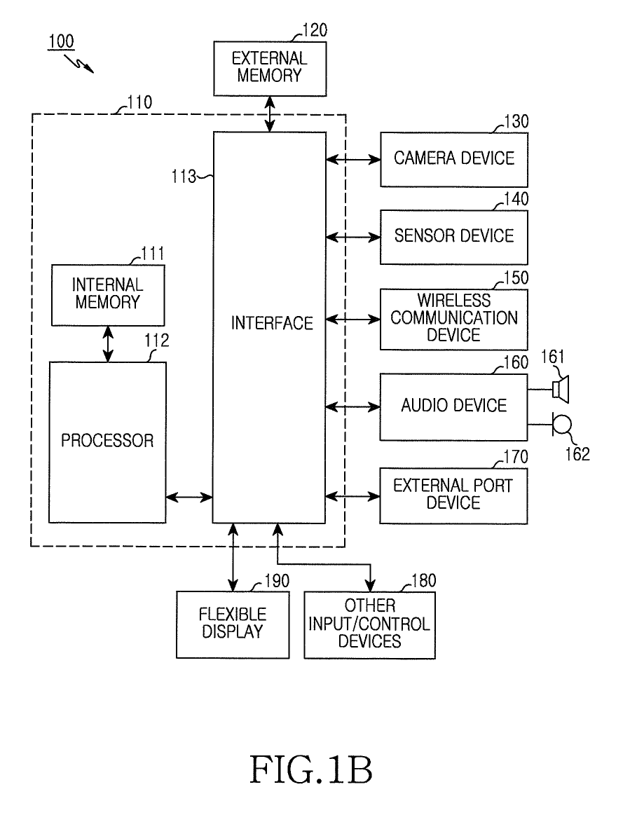

FIGS. 1A through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless electronic device. Preferred embodiments of the present disclosure will be described herein below with reference to the accompanying drawings. In the following description, detailed descriptions of well-known functions or constructions will be omitted since they would obscure the invention in unnecessary detail.

FIG. 1A illustrates flexing of an electronic device according to embodiments of the present disclosure, and FIG. 1B illustrates a configuration of an electronic device according to embodiments of the present disclosure.

Referring to FIGS. 1A and 1B, the electronic device 100 can be a mobile phone, a mobile pad, a media player, a tablet computer, a handheld computer, or a PDA. Also, the electronic device 100 can be an arbitrary electronic device including a device having two or more functions combined from among the above devices.

The electronic device 100 includes a flexible display 190 and is formed to be flexible and foldable. The electronic device 100 as shown in FIG. 1A is carried in a state where the flexible display 190 is typically folded inside. The flexible display 190 can be a double sided display that can be monitored in double sides and can be folded reversely.

The electronic device 100 includes a host device 110, an external memory device 120, a camera device 130, a sensor device 140, a wireless communication device 150, an audio device 160, an external port device 170, a flexible display 190 and other input/control devices 180. The external memory device 120 and the external port device 170 can be formed in plural.

The host device 110 includes an internal memory 111, one or more processors 112, and an interface 113. The internal memory 111, the one or more processors 113, and the interface 113 can be separate elements or formed in one or more integrated circuits.

The processor 112 determines a display area of the flexible display 190 according to bending information of the flexible display 190 and controls to display content on the display area. Here, the bending information includes a bended line position, or a bended line position and a bended angle of the bended line of the flexible display 190. The sensor device 140 obtains the bending information on the flexible display 190. The sensor device 140 provides the obtained bending information to the processor 112. The processor 112 confirms the provided bending information and determines the display area of the flexible display 190. Also, the processor 112 controls to display content on the determined display area. Besides, the processor 112 executes various software programs, performs various functions for the electronic device 100, and processes and controls for voice, video and data communications. In addition to these typical functions, the processor 112 executes software programs, namely, instruction sets, stored in the internal memory 111 or the external memory device 120 and performs various functions corresponding to the software programs. In addition, the processor 112 includes one more data processors, image processors, or codecs. Furthermore, the electronic device 100 can separately include the data processors, the image processors, or the codecs. The information can be, but not limited hereto, the term indicating a value, a parameter, a coefficient, or a component.

The interface 113 connects various devices of the electronic device 100 and the host device 110.

The camera device 130 performs camera functions such as photo and video clip recording, and includes a charge coupled device (CCD) or a complementary metal-oxide-semiconductor (CMOS) image sensor. Also, the camera device 130 adjusts a hardware configuration, for example, a lens movement, or the number of apertures according to a camera program executed by the processor 112.

Various elements of the electronic device 100 may be connected through one or more communication buses (not shown) or streamlines (not shown).

The sensor device 140 includes at least one sensor capable of detecting movement, light, temperature, tension, modification, and the like. The sensor device 140 measures information on modification of the electronic device 100 and transfers the measured information to the processor 112. The modification includes at least one of: bending, flexing, and twisting. For example, the bending information includes a bended line position, or a bended line position, and a bended angle of the bended line of the flexible display 190. The sensor device 140 obtains bending information on the entire flexible display 190, and transfers the obtained bending information to the processor 112. The sensor device 140 is attached to a rear surface of the flexible display 190.

The wireless communication device 150 enables wireless communication and includes a wireless frequency transmitter and receiver, or light (for example, an infrared) transmitter and receiver. The wireless communication device 150 can be configured to operate through one of a global system for mobile communications (GSM) network, an enhanced data for global evolution (EDGE) network, a code division multiple access (CDMA) network, a wideband-CDMA (W-CDMA) network, a long term evolution (LTE) network, an orthogonal frequency-division multiplexing (OFDM) network, a Wi-Fi network, a WiMax network, and/and a bluetooth network.

The audio device 160 is connected to a speaker 162 and a microphone 162, and performs audio input and output functions such as speech recognition, speech reproduction, digital recording, and calling. That is, the audio device 160 communicates with a user through the speaker 161 and the microphone 162. The audio device 160 receives a data signal from the host device 110, converts the data signal into an electrical signal, and outputs the converted electrical signal to the speaker 161.

The speaker 161 converts the electrical signal into an audio frequency band signal and outputs the audio frequency band signal. The speaker 161 is disposed at a rear side of the electronic device 100, and includes a flexible film speaker that includes at least one piezoelectric unit attached to one vibration film.

The microphone 162 converts an acoustic wave output from humans or other sound sources into an electrical signal. Also, the audio device 160 receives the electrical signal from the microphone 162, converts the received electrical signal into an audio data signal, and transmits the converted audio signal to the host device 110. The audio device 160 includes ear phones, a head phone or a headset which is removably coupled to the electronic device 100.

The external port device 170 directly connects the electronic device 100 to another electronic device or indirectly connects the electronic device 100 to another electronic device through a network (for example, the internet, an intranet or a wireless LAN, and the like). This external port device 170 includes a terminal unit which is disposed in a rear side of the electronic device 100.

The flexible display 190 displays a signal received from the host device 110 as an image of a text, a graphic, or a video. The flexible display 190 includes a double sided display capable of displaying in double sides. The flexible display 190 can include a touch screen technology.

The other input/control devices 180 include up/down buttons for a volume control. Other input/control devices 180 can include at least one of pointer devices such as a push button, a rocker button, a thumb wheel, a dial, a stick, and a stylus, which have corresponding functions.

The external memory device 120 includes one or more high speed RAMs such as magnetic disk storage devices or one or more optical storage devices, or a flash memory (for example, NAND, NOR). The external memory device 120 stores software, and the software includes an operating system program, a communication program, a graphic program, a user interface program, a codec program, and one or more application programs. The term ‘program’ is expressed as an instruction set, or a set or a module of instructions.

The operating system program indicates an embedded operating system, such as WINDOWS, LINUX, Darwin, RTXC, UNIX, OS X, or VxWorks, and includes various software elements controlling general system operations. This control of the general system operations includes memory management and control, storage hardware (device) control and management, and power control and management. Also, the operating system program performs functions of speeding up communication among various hardware devices and software elements (programs).

The communication program enables communication with a computer, a server, and an electronic device through the wireless communication device 150 or the external port device 170.

The graphic program provides graphics to the flexible display 190 and includes various software elements for display. The term ‘graphics’ indicates a text, a web page, an icon, a digital image, a video, an animation, etc.

The user interface program includes various software elements related to the user interface. Also, the user interface program includes contents about how a state of the user interface changes, and under what condition the user interface state is changed.

The codec program includes software elements related to encoding and decoding of video files.

The camera program includes camera related software elements enabling camera related processes and functions.

The application program includes a browser, an email, an instant message, a word processing, keyboard emulation, an address book, a contact list, a widget, digital rights management (DRM), speech recognition, speech reproduction, a position determination function, and a location based service, and the like.

The host device 110 can further include additional programs (instructions) besides the above described programs. Further, various functions of the electronic device 100 according to the present disclosure include hardware and software including one or more stream processes or application specific integrated circuits (ASIC).

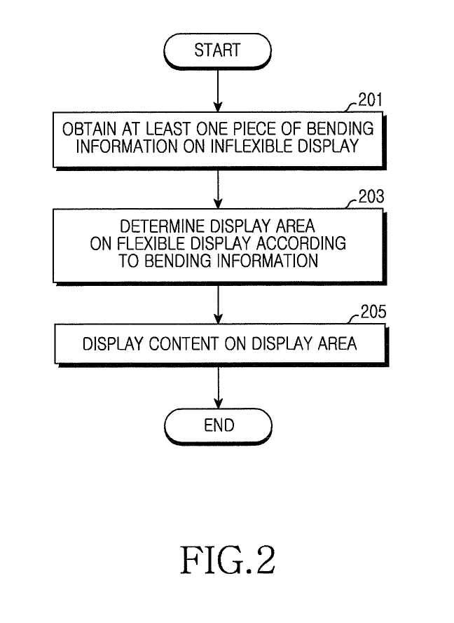

FIG. 2 illustrates a method of operation of an electronic device according to embodiments of the present disclosure.

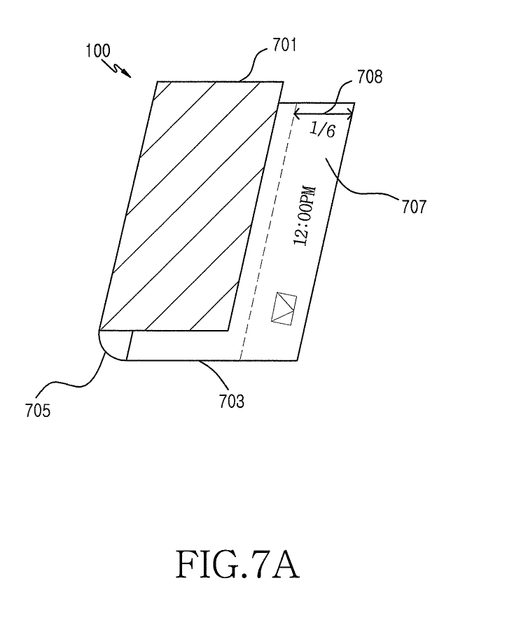

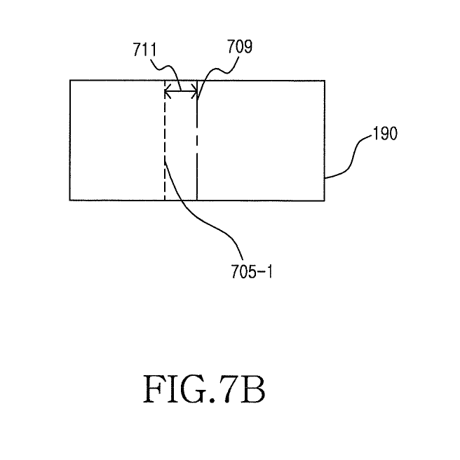

Referring to FIG. 2, in operation 201, the sensor device 140 obtains at least one piece of bending information on the flexible display 190. Here, the term ‘bending’ is a concept including at least one of twisting, flexing, and folding. Also, the ‘bending information’ includes a bended line position, or a bended line position and a bended angle of the bended line of the flexible display 190. Furthermore, a line, which connects points on which the largest tension is applied on one axis of the flexible display 190, is determined as a position of the bended line. The bending information may be detected through the sensing device 140, and in particular, the sensor device 140 includes a tension sensor obtaining bending information on the entire flexible display 190. This tension sensor is attached to a rear side of the flexible display 190 and measures tension of the flexible display 190. For example, referring to FIGS. 7A and 7B, when the flexible display 190 is folded, the sensor device 140 measures tension of the flexible display 190 and obtains a position of a bended line 705-1. The sensor device 140 provides the obtained position to the processor 112.

Then, in operation 203, the processor 112 determines a display area of the flexible display 190 according to bending information. The processor 112 confirms the bending information (for example, the position of the bended line) provided from the sensor device 140 and determines the display area of the flexible display 190. The processor 112 determines the display area by comparing the distance between the bended line position and a center line of one axis of the flexible display 190. The determined display area is exposed to a user as shown in a portion 707 of a display of FIG. 7A. The exposed part 707 can be an edge of the flexible display 190, and be divided into two parts.

In operation 205, the processor 112 controls to allow content to be displayed on the display area of the flexible display 190. The content may be, for example, a current time, a date, strength bars of a reception signal, the number of received messages, etc. Also, text of the content may have a font changed and a size enlarged or reduced according to the display area.

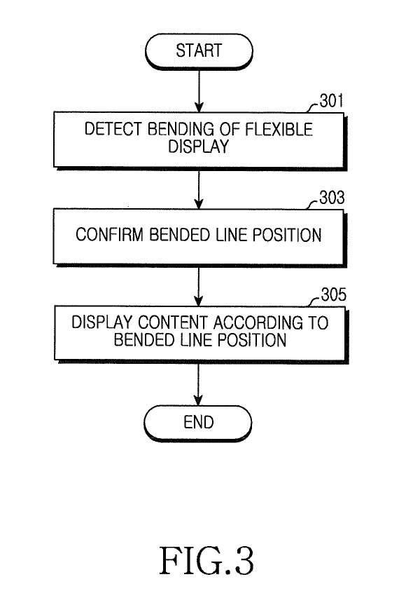

FIG. 3 illustrates a method of an electronic device according to embodiments of the present disclosure.

Referring to FIG. 3, in operation 301, the sensor device 140 detects bending of the flexible display 190. Here, the term ‘bending’ is a concept including one of: twisting, flexing, and folding. The sensor device 140 includes a tension sensor detecting bending of the entire flexible display 190. This tension sensor is attached to a rear side of the flexible display 190, and measures tension to detect bending of the flexible display 190.

In operation 303, the sensor device 140 confirms a bended line position of the flexible display 190. Here, the sensor device 140 determines a line, which connects points on which the largest tension is applied on one axis of the flexible display 190, to be a position of the bended line. Also, this bended line position is provided to the processor 112.

Then, in operation 305, the processor 112 displays content according to the bended line position.

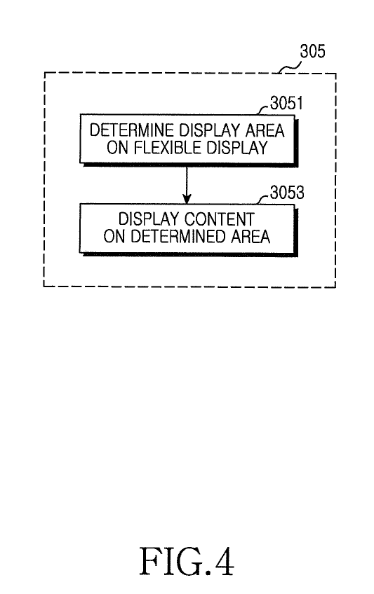

The operation 305 is described in detail in relation to FIG. 4.

FIG. 4 is a flow chart illustrating the operation 305 of FIG. 3 according to embodiments of the present disclosure.

Referring to FIG. 4, in operation 3051, the processor 112 determines a display area of the flexible display 190 according to the position of the bended line. The processor 112 determines the display area through distance comparison between (namely, by comparing the distances of) the bended line position and a center line of one axis of the flexible display. The determined display area is exposed to a user as shown in a part 707 of a display of FIG. 7A. The exposed part can be an edge of the flexible display, and be divided into two parts.

In operation 3053, the processor 112 controls to allow content to be displayed in the display area of the flexible display 190. Also, the content can be a current time, a date, strength bars of a reception signal, the number of received messages, and the like. Furthermore, text of the content can have a font changed, and a size enlarged or reduced according to the display area.

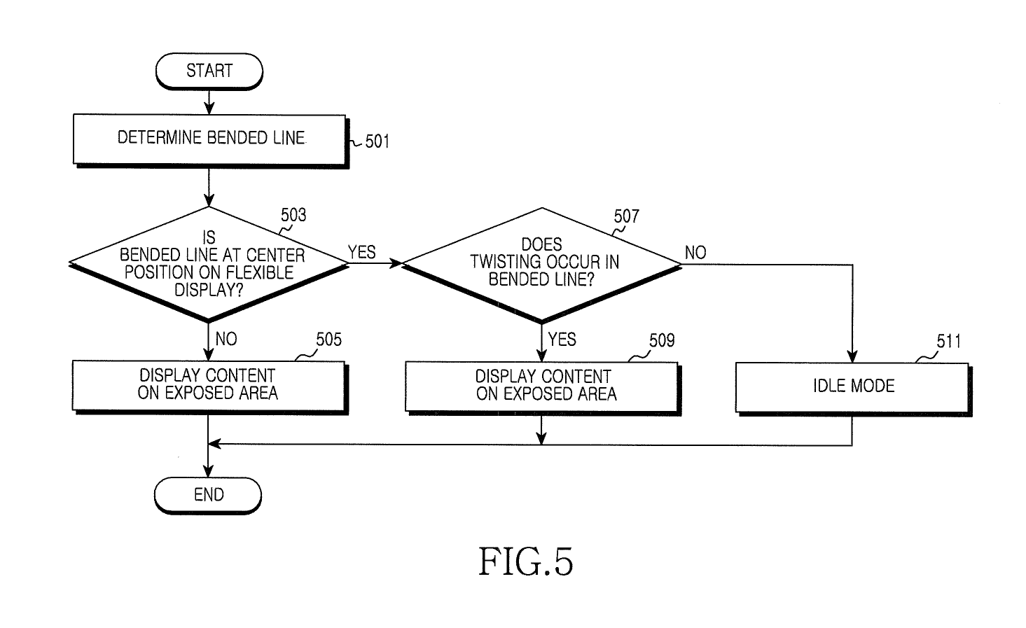

FIG. 5 is a flow chart illustrating a method of operating an electronic device according to embodiments of the present disclosure.

Referring to FIG. 5, in operation 501, the sensor device 140 determines a bended line position of a folded flexible display 190. The bended line position is included in bending information of the flexible display 190. The sensor device 140 includes a tension sensor measuring tension of the flexible display 190. Also, the sensor device 140 determines a line, which connects points on which the largest tension is applied on any one axis of a horizontal axis and a vertical axis of the flexible display 190, to be a position of the bended line. When the electronic device 100 is folded, the tension source imposes a pulling force or a pulled force on the flexible display 190. The bended line can be a vertical or horizontal straight line or a diagonal line on the flexible display 190. Also, the bended line can be located at a center of the flexible display 190. The bended line position varies according to a folded direction and a folded angle of the flexible display 190. When the flexible display 190 is folded several times, the flexible display 190 can include several bended lines.

Next, in operation 503, the processor 112 confirms the bended line position is located on a center of the flexible display 190. Here, when the bended line is not located on the center of the flexible display 190, as in operation 505, the processor 112 controls to allow the content to be displayed on an exposed area of the flexible display 190. The content is as described above, and the exposed area is exposed to a user as a part 707 of the display of FIG. 7A. In detail, the exposed area is determined according to a bended line position and a bended angle of the bended line. A line, which connects points on which the largest tension is the largest on any one axis of a horizontal axis and a vertical axis of the flexible display 190, is determined to be a bended line position. For example, the exposed area is determined through distance comparison between one axis and a center line of the flexible display 190. When the bended line is not located on the center of the flexible display 190 as shown in FIG. 7B, the exposed area is determined by comparing a distance 711 between a bended line 705-1 and a center line 709 of the flexible display 190. However, when the distance 711 between the bended line 705-1 and the center line 709 is within a predetermined length (for example, 5 mm) or smaller, the processor 112 determines the bended line 705-1 to be located at the center.

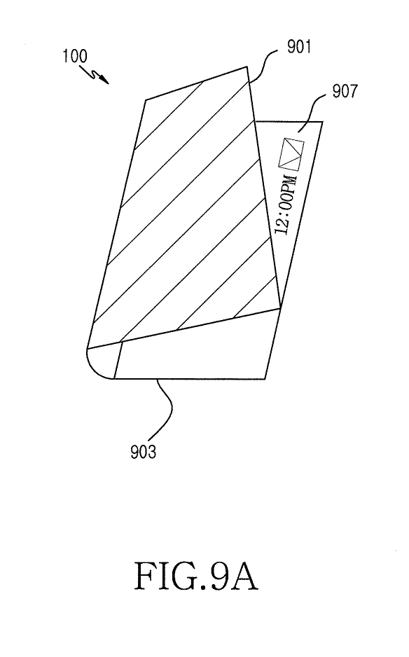

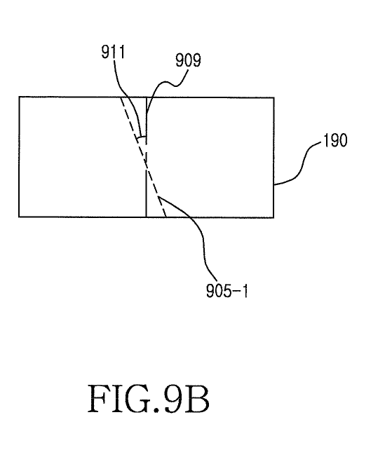

Then, when the bended line is located at the center of the flexible display 190 as shown in operation 507, the processor 112 confirms whether the bended line twisting occurs. Here, the bended line twisting occurs by twisting a folded flexible display 190 as shown in FIG. 9A and the bended line is represented on a plane of the flexible display 190. This bended line has a slope changed according to a form of the flexible display 190. Also, when the flexible display 190 is folded several times, it has one or more bended lines. Like this, when the bended line twisting occurs, the processor 112 controls to allow content to be displayed on the exposed area as an operation 509. For example, as shown in FIG. 9B, the exposed area is changed according to a center line 909 and an angle 911 of the bended line 905-1. The exposed line can be an edge of the flexible display 190, and can be divided into two parts.

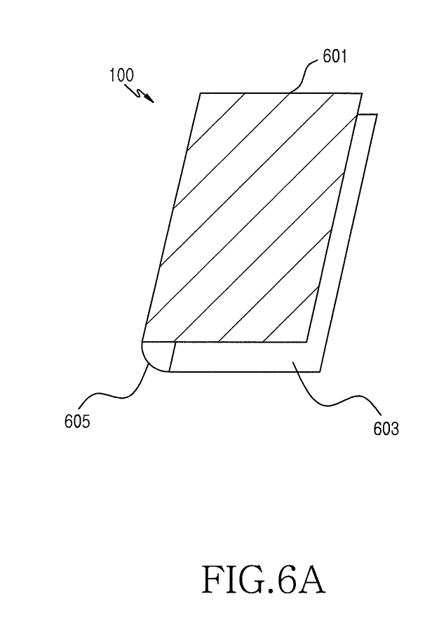

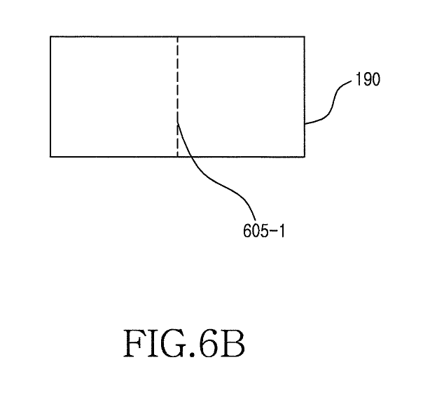

Then, when the bended line does not occur, as shown in operation 511, the processor 112 is converted into an idle mode, namely, a sleep mode. That is, as shown in FIGS. 6A and 6B, when the electronic device 100 is folded in half, the bended line 605-1 is located at a center of the flexible display 190 in a vertical line form. In this case, the electronic device 100 is converted into an idle mode, which does not display anything on the display area of the flexible display 190.

FIGS. 6A and 6B illustrate methods of operating an electronic device according to embodiments of the present disclosure.

Referring to FIGS. 6A and 6B, the electronic device 100 is folded in half. The electronic device 100 has a shape of an upper plate 601 stacked on a lower plate 603, and a curved bending unit 605 connecting the upper plate 601 and the lower plate 603 is formed at edges. Also, the flexible display 190 is composed from an elastic material so as to be freely modified. When the upper plate 601 is pushed in one side, the upper plate 601 becomes smaller and the lower plate 603 becomes relatively larger. As shown in the drawing, when the electronic device 100 is folded in half, and the upper plate 601 entirely covers the lower plate 603, the upper plate 601 fully hides the lower plate 603 and the display is not exposed. A position of the bending unit 605 is, as shown in FIG. 6B, represented as a bended line 605-1 on the flexible display 190. The bended line 605-1 is detected by the sensor device 140. This sensor device 140 is a tension sensor, and the tension sensor is attached to a rear surface of the flexible display 190. The sensor device 140 determines a line, which connects points on which the largest tension is applied on one axis of the flexible display 190, to be the bended line 605-1. The sensor device 140 provides the position of the bended line 605-1 to the processor 112. The processor 112 determines a display area on the flexible display 190 according to the position of the bended line 605-1, and controls content to be displayed on the determined display area. For example, the processor 112 determines the display area through distance comparison between the position of the bended line 605-1 and a center line on one axis of the flexible display 190. However, as an exceptional case as shown in the drawing, when the position of the bended line 605-1 is located on the center of the flexible display 190, the processor 112 converts the flexible display 190 into an idle mode. Also, a distance from this bended line 605-1 to the center of the flexible display 190 is a predetermined length (for example, 5 mm) or smaller, the processor 112 determines the bended line 605-1 to be located on the center.

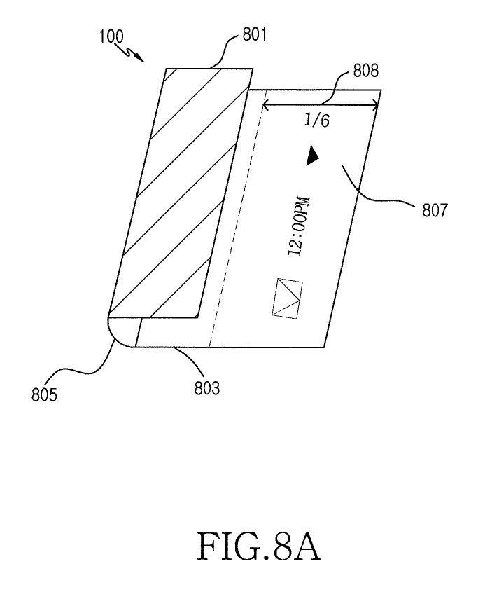

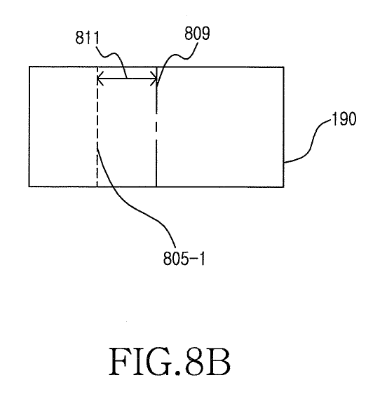

FIGS. 7A and 8A illustrate methods of operating an electronic device according to embodiments of the present disclosure.

Referring to FIGS. 7A and 8A, the electronic device 100 is folded in half as shown in FIG. 6A with the upper plate 701 pushed horizontally. When the upper plate 701 is pushed in one side, as described above, the upper plate 701 is smaller and the lower plate 703 is relatively larger to form one bending unit 705. Also, the position of the bended line 705-1 is moved. More particularly, when the upper plate 701 is pushed to increase an exposed distance 708, a distance 712 from the bended line 705-1 to the center line 709 is increased. The processor 112 determines the display area of the flexible display 190 according to the position of the bended line 705-1, and controls to allow the content to be displayed on the determined display area. As shown in FIG. 7A, when the upper layer 701 does not entirely hide the lower plate 703 and a part 707 of the display is exposed, content is displayed on the exposed part 707 of the display. For example, when the position of the bended line 705-1 is moved to the left side of the center line 709 of the flexible display 190, the processor 112 displays the content on a part of the right side the flexible display 190. When the bended line 705-1 is moved to the right side, the processor 112 displays the content on a portion of the left side of the flexible display 190. The content can include a current time, data, strength bars of the reception signal, and the number of received messages. For example, when the upper plate 801 is further pushed horizontally as shown in FIG. 8A, a distance 811 from the bended line 805-1 to the center line 809 increases as the exposed distance 808 increases. Also, the electronic device 100 further exposes a part 807 of the display and the position of the bended line 805-1 corresponding to the bending unit 805 further moves. In this case, the content displayed on the part 807 of the display enlarges or is added to.

FIGS. 9A and 9B illustrate methods of operating an electronic device according to embodiments of the present disclosure.

Referring to FIGS. 9A and 9B, the electronic device 100 is folded in half as shown in FIG. 6A and has the upper and lower plates 901 and 903 twisted and dislocated from each other. Also, the bended line 905-1 is a diagonal line on the flexible display 190 and has an angle 911 with the center line 909. The upper plate 901 does not entirely hide the lower plate 903, exposes a part 907 of the display and displays content on the exposed part 907 of the display. The processor 112 determines the display area of the flexible display 190 according to the position of the bended line 905-1, and determines content to be displayed on the determined display area. For example, the processor measures the angle 911 between the bended line 905-1 and the center line 909 to determine the display area. The content as described above is displayed and the content becomes enlarged or reduced, or added to.

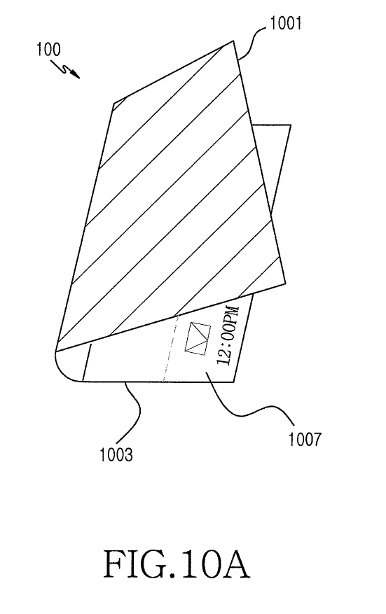

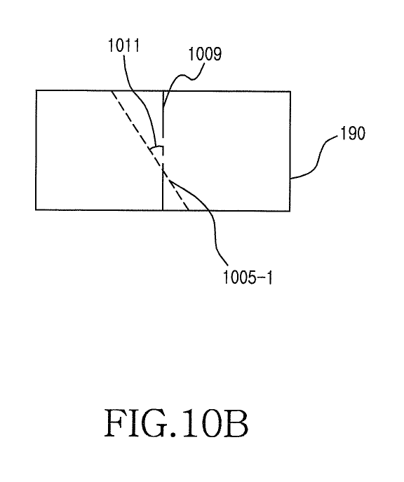

FIGS. 10A and 10B illustrate method of operating an electronic device according to embodiments of the present disclosure.

Referring to FIGS. 10A and 10B, the electronic device 100 is folded in half as shown in FIG. 6A and has the upper and lower plates 1001 and 1003 further twisted and further dislocated from each other. Also, the bended line 1005-1 becomes a diagonal line on the flexible display 190, and further inclined than the bended line 905-1 of FIG. 9B. Furthermore, an angle 1011 between the bended line 1005-1 and the center line 1009 is also larger than the angle 911 of FIG. 9B. The upper plate 1001 does not hide the lower plate 1003 and exposes a portion 1007 of the display, and content is displayed on the exposed portion 1007 of the display. The processor 112 determines a display area of the flexible display 190 according to the position of the bended line 1005-1, and determines content to be displayed on the determined display area. For example, the processor 112 measures the angle 1011 between the bended line 1005-1 and the center line 1009 to determine the display area. The content as described above is displayed and the content can be enlarged or reduced, or added to. The exposed portion 1007 of the display on which the content is displayed can be on a right top side (shown as the exposed portion 907 in FIG. 9A), or on a right bottom side as shown in the drawing. That is, a position and a slope of the bended line 1005-1 are changed and a display area is changed according to a form of the electronic device 100.

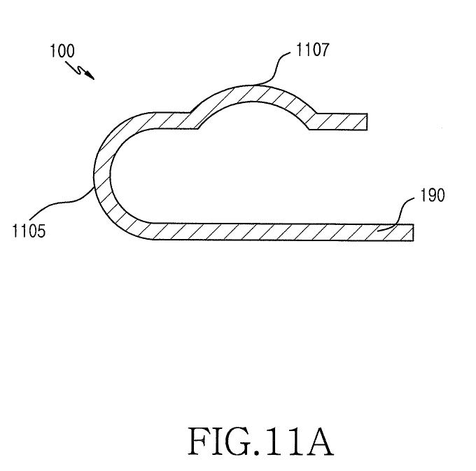

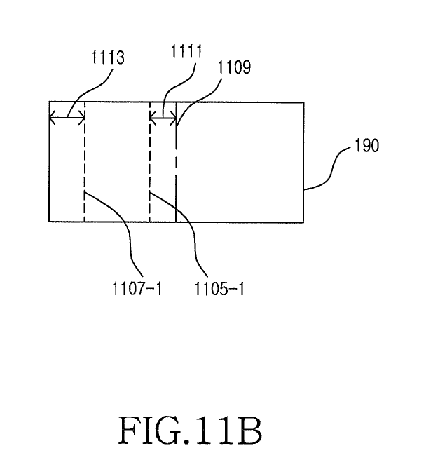

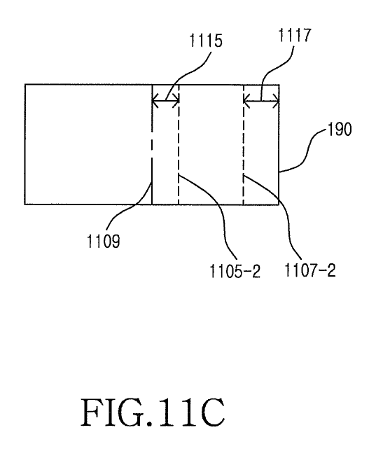

FIGS. 11A to 11C illustrate a state where the flexible display is bended twice according to embodiments of the present disclosure.

Referring to FIG. 11A, the electronic device 100 includes a first bending unit 1105 and a second bending unit 1107 in the flexible display 190. Also, as shown in FIG. 11B, on the flexible display 190, a first bended line 1105-1 and a second bended line 1107-1 corresponding to the first bending unit 1105 and the second bending unit 1107 are represented. That is, when the two bended lines are formed, the processor 112 determines a display area through distance comparison between the two bended lines and one axis of the center of the flexible display 190. For example, the first bended line 1105-1 determines a first display area on the display. Also, the second bended line 1107-1 becomes a criterion for determining a second display area to which a display area is added with reference to the first display area. Content described above is displayed on this determined display area. Furthermore, when the electronic device is reversely folded as shown in FIG. 11C, the first and second bended line 1105-2 and 1107-2 are represented in a reverse side, and the content is displayed on the left side of the flexible display 190.

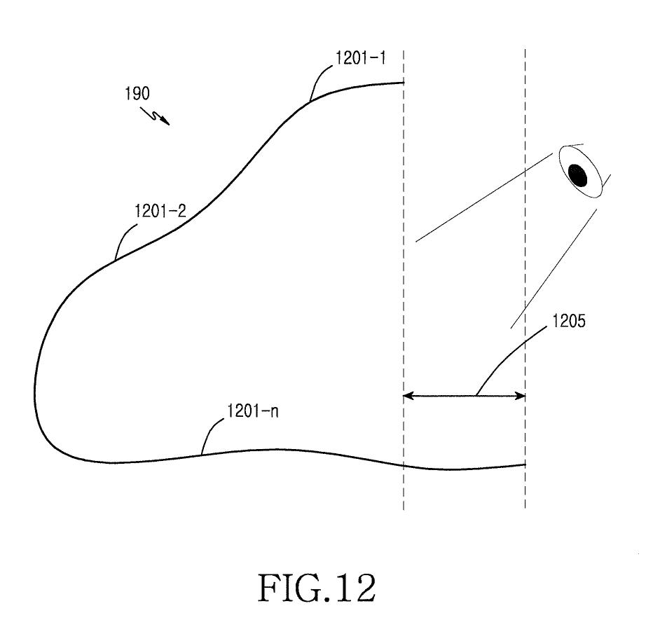

FIG. 12 illustrates a state where the flexible display is modified according to embodiments of the present disclosure.

Referring to FIG. 12, the sensor device 140 obtains bending information of the flexible display 190. Here, the bending information includes a bended line position, or a bended line position and an angle of the bended line of the flexible display 140. The sensor device 140 provides the bending information obtained at all positions 1201-n to the processor 112. The processor 112 confirms this bending information, determines the display area 1205, and controls to allow content to be displayed on the determined display area 1205. For example, as shown in FIG. 12, the flexible display 190 can be bended several times, and has several bended lines corresponding to the several times bending. The processor 112 determines the display area 1205 by confirming the bending information of the bended lines. The display area can be exposed to a user when the flexible display 190 is folded. Also, the display area 1205 displays the above described content. As shown in the drawing, the electronic device 100 can have arbitrary form and includes a display method corresponding to the form.

Claimed methods according to embodiments described herein can be implemented by hardware, software, or combination thereof.

When the method is implemented with software, a computer-readable recording media storing one or more programs (software modules) are provided. The one or more programs stored in the computer readable recoding media are configured to be able to be executed by one or more processors in an electronic device. The one or more programs include instructions allowing the electronic device to execute methods according to embodiments described in claims and/or description of the present disclosure.

These programs (software modules, or software) can be stored in a nonvolatile memory including a random access memory, or a flash memory, electrically erasable programmable ROM (EEPROM), a magnetic disk storage device, a compact disc ROM (CD-ROM), a digital versatile disc (DVD), or other type optical storage device, or a magnetic cassette. Or these programs can be stored in a memory formed of some or entire combination of these memories. Furthermore, each configuration memories can be included in plural.

Alternatively, the programs can be also stored in an attachable storage device which is accessible to the electronic device through a communication network such as the internet, an intranet, a LAN, a WLAN, or a storage area network (SAN), or combination thereof. These storage devices access to the electronic device through an external port.

Furthermore, a separate storage device on the communication network can access to a mobile electronic device.

An electronic device and an operating method thereof according to the present disclosure employ a flexible display and can provide an improved content display method allowing simple content such as a current time, a date or the number of received massage to be watched without unfolding a folded flexible display, when the flexible display is folded for carrying.

While the invention has been shown and described with reference to certain embodiments, it will be understood by those skilled in the art that various changes in form and details may be made therein without departing from the spirit and scope of the invention as defined by the appended claims. Therefore, the scope of the invention is defined not by the detailed description but by the appended claims, and all differences within the scope will be construed as being included in the present disclosure.

What is claimed is:

1. A method implemented in an electronic device, the method comprising:
obtaining at least one piece of bending information on a flexible display;
determining at least one display area on the flexible display according the obtained bending information; and
displaying content on the determined display area.

2. The method of claim 1, wherein the bending information comprises one of:
a position of a bended line, and
the position of the bended line and a bending angle of the bended line of the flexible display.

3. The method of claim 2, further comprising determining the position of the bended line by measuring tension of the flexible display when the flexible display is folded.

4. The method of claim 3, further comprising determining the position of the bended line by connecting points on which the largest tension is applied on one axis of the flexible display.

5. The method of claim 4, wherein the determining the at least one display area comprises determining through distance comparison between the bended line and a center line of the one axis of the flexible display.

6. The method of claim 1, further comprising, converting the flexible display into an idle mode when a bended line position of the flexible display, which corresponds to the bending information, is identical to a center line of one axis of the flexible display.

7. The method of claim 1, wherein the content comprises at least one of a current time, a current date, a message reception notification, and a set alarm mark.

8. An electronic device comprising:
a sensor device configured to obtain bending information on a flexible display;
a processor configured to determine a display area on the flexible display according to the bending information; and
a flexible display configured to display content corresponding to the bending information on the display area.

9. The electronic device of claim 8, wherein the bending information comprises one of:
a bended line position, and
the bended line position and a bending angle of the bended line of the flexible display.

10. The electronic device of claim 9, wherein, in response to a fold of the flexible display, the sensor device is configured to measure tension of the flexible display to determine the bended line position.

11. The electronic device of claim 10, wherein the sensor device is configured to determine a line connecting points on which the largest tension is applied on one axis of the flexible display to be the bended line position.

12. The electronic device of claim 11, wherein the processor is configured to determine the display area through distance comparison between the bended line position and a center line of the one axis of the flexible display.

13. The electronic device of claim 8, wherein, in response to a determining a bended line position of the flexible display, which corresponds to the bending information, is identical to a center line on one axis of the flexible display, the processor converts the flexible display into an idle mode.

14. The electronic device of claim 8, wherein the content comprises at least one of a current time, a current date, a message reception notification, and a set alarm mark.

15. An electronic device comprising:
a sensor device configured to obtain bending information on a flexible display;
at least one processor;
a memory; and
at least one program stored in the memory and configured to be executed by the at least one processor,
wherein the program includes instructions to determine a display area of the flexible display according to the bending information, and display content corresponding to the bending information on the display area.

16. The electronic device of claim 15, wherein the bending information comprises one of:
a bend line position, and
the bended line position and a bending angle of the bended line of the flexible display.

17. The electronic device of claim 16, wherein, the sensor device is further configured to, in response to a fold of the flexible display, determine the bended line position by measuring tension of the flexible display.

18. The electronic device of claim 17, wherein the sensor device is configured to determine a line connecting points on which the largest tension is applied on one axis of the flexible display to be the bended line position.

19. The electronic device of claim 18, wherein the processor is configured to determine the display area through distance comparison between the bended line position and a center line of the one axis of the flexible display.

20. The electronic device of claim 15, wherein, the processor is configured to, in response to determining a bended line position of the flexible display, which corresponds to the bending information, is identical to a center line on one axis of the flexible display, convert the flexible display into an idle mode.
